(19) United States
(12) Patent Application Publication
(10) Pub. No.: US 2011/0018982 A1
(43) Pub. Date: Jan. 27, 2011

(54) Video game apparatus, game information display control method and game information display control program

(75) Inventors: Masakazu Shibamiya, Tokyo (JP); Yoshitaka Adachi, Tokyo (JP); Taichi Takeuchi, Tokyo (JP)

Correspondence Address: JORDAN AND HAMBURG LLP, 122 EAST 42ND STREET, SUITE 4000, NEW YORK, NY, 10168, US

(73) Assignee: Konami Digital Entertainment Co., Ltd., Minato-ku (JP)

(21) Appl. No.: 12/804,324

(22) Filed: Jul. 20, 2010

(30) Foreign Application Priority Data
Jul. 22, 2009 (JP) 2009-170653

(51) Int. Cl. H04N 13/04

(52) U.S. Cl. 348/54; 348/E13.074

(57) ABSTRACT

A video game apparatus 1 includes: storage block 163a that stores left eye-use and right eye-use images forming each of objects individually in a first aspect where a spaced distance is zero and a second aspect where the spaced distance has a predetermined value; processor 161k that determines whether or not each of the objects to be displayed is capable of being designated; controller 161c that individually reads out, in the second aspect, both images of the object capable of being designated, and otherwise in the first aspect, from the both image storage block, then guides the read out the both images to one displaying storage block to then synthesize the both images with each other there, and thereafter, reads out the synthesized image to a monitor 11 capable of 3D stereoscopic display; and a processer 161m that receives designation to the object displayed in the second aspect.

### CROSS REFERENCE

This Nonprovisional application claims priority under 35 U.S.C. §119(a) on Patent Application No. 2009-170653 filed in Japan on Jul. 22, 2009, the entire contents of which are hereby incorporated by reference.

### BACKGROUND OF THE INVENTION

(1) Field of the Invention

The present invention relates to a video game apparatus and a game information display control technology, which are for displaying game information in a three-dimensional manner (stereoscopically).

(2) Description of the Related Art

Heretofore, a configuration has been adopted, in which selectable buttons are displayed on a screen, and colors of the buttons are differentiated from one another in order to notify an operator of functions owned by the respective buttons. For example, in FIG. 8 of Japanese Patent Laid-Open Publication No. 2001-202175, a configuration is illustrated, in which a plurality of homing pigeon images with different colors are displayed, and when a homing pigeon image with any one of the colors is selected, a function associated in advance with the color given to the selected homing pigeon image is executed.

Moreover, recently, a variety of technologies for displaying a 3D image on a display screen have been proposed. As a display method of the 3D image, the parallax barrier method is general, and particularly well known are: the so-called glass method using a polarization material, a liquid crystal shutter and glasses; and as examples of the non-glass method, the parallax panoramagram method, the lenticular method, and the like. Furthermore, in recent years, a display technology capable of switching between a 2D image and a 3D image has been proposed. In Japanese Patent No. 3973525, a monitor screen is described, in which a liquid crystal panel realizing the parallax barrier method is provided. Moreover, Japanese Patent No. 3973525 describes a portable personal computer and a cellular phone, which are configured in the following manner. Specifically, when two-dimensional display is selected, a barrier by the liquid crystal panel is not operated, and meanwhile, when three-dimensional display is selected, the barrier by the liquid crystal panel is operated, and at this time, a left eye-use image and a right eye-use image, which form a three-dimensional image created based on image data received from an external storage medium through a network, are guided to the monitor screen, whereby the three-dimensional image is displayed.

In recent years, as well as in Japanese Patent Laid-Open Publication No. 2001-202175, buttons and icons are also colored with a variety of colors to be filled therewith, and there are limitations on such an aspect of making the individual functions visible simply by the coloring expression. In this case, it is preferable to fully use the display technology of the 3D image. However, Japanese Patent No. 3973525 only describes so-called switching display of performing screen switching between the 2D display and the 3D stereoscopic display by depression of an operation key, and in addition, the icons and the buttons are not displayed.

### SUMMARY OF THE INVENTION

It is an object of the present invention to provide a video game apparatus, a game information display control method and a game information display control program, which are for displaying a plurality of objects separately into the 2D display and the 3D stereoscopic display in response to whether or not the objects are selected, thereby making it easy to visually recognize a state as to whether or not each of the objects is selected.

A video game apparatus according to the present invention is a video game apparatus that selectably presents, to a player, a variety of objects with which contents regarding a game are associated, the video game apparatus including: a display section in which a parallax barrier member enabling 3D stereoscopic display is arranged on a display screen; a left eye-use and right eye-use object image storage block that stores left eye-use and right eye-use images forming each of the objects individually in a first aspect where a spaced distance is zero and a second aspect where the spaced distance has a predetermined value; a designation enable/disable determination processor that determines, in response to at least one of game circumstances and information regarding the player, whether or not each of the objects to be displayed is capable of being designated; an image display controller that individually reads out, in the second aspect, the left eye-use and right eye-use images of the object capable of being designated, and in the first aspect, the left eye-use and right eye-use images of the object incapable of being designated, from the left eye-use and right eye-use object image storage block, then guides the read out left eye-use and right eye-use images to one displaying storage block to then synthesize the left eye-use and right eye-use images with each other there, and thereafter, reads out the synthesized image to the display section, and displays the synthesized image on a predetermined position of the display section; and a selection processer that receives designation to any of the objects displayed in the second aspect on the display section.

Moreover, a game information display control method according to the present invention is a game information display control method of a video game apparatus that includes a display section in which a parallax barrier member enabling 3D stereoscopic display is arranged on a display screen, and selectably displays, on the display section, a variety of objects with which contents regarding a game are associated, the game information display control method including: allowing a left eye-use and right eye-use object image storage block to store left eye-use and right eye-use images forming each of the objects individually in a first aspect where a spaced distance is zero and a second aspect where the spaced distance has a predetermined value; allowing a designation enable/disable determination processor to determine, in response to at least one of game circumstances and information regarding a player, whether or not each of the objects to be displayed is capable of being designated; allowing an image display controller to individually read out, in the second aspect, the left eye-use and right eye-use images of the object capable of being designated, and in the first aspect, the left eye-use and right eye-use images of the object incapable of being designated, from the left eye-use and right eye-use object image storage block, then to guide the read out left eye-use and right eye-use images to one displaying storage block and then synthesize the left eye-use and right eye-use images with each other there, and thereafter, to read out the synthesized image to the display section, and to display the synthesized image on a predetermined position of the display section; and allowing a selection processer to receive designation to any of the objects displayed in the second aspect on the display section.

Moreover, a game information display control program according to the present invention is a game information display control program of a video game apparatus that includes a display section in which a parallax barrier member enabling 3D stereoscopic display is arranged on a display screen, and selectably displays, on the display section, a variety of objects with which contents regarding a game are associated, the game information display control program allowing the video game apparatus to function as: a left eye-use and right eye-use object image storage block that stores left eye-use and right eye-use images forming each of the objects individually in a first aspect where a spaced distance is zero and a second aspect where the spaced distance has a predetermined value; a designation enable/disable determination processor that determines, in response to at least one of game circumstances and information regarding a player, whether or not each of the objects to be displayed is capable of being designated; an image display controller that individually reads out, in the second aspect, the left eye-use and right eye-use images of the object capable of being designated, and in the first aspect, the left eye-use and right eye-use images of the object incapable of being designated, from the left eye-use and right eye-use object image storage block, then guides the read out left eye-use and right eye-use images to one displaying storage block to then synthesize the left eye-use and right eye-use images with each other there, and thereafter, reads out the synthesized image to the display section, and displays the synthesized image on a predetermined position of the display section; and a selection processer that receives designation to any of the objects displayed in the second aspect on the display section.

In accordance with these inventions, it becomes possible for the player to view the game image in the 3D stereoscopic display mode through the display section. On the display section, the variety of objects with which the contents regarding the game are associated are displayed, and with regard to the objects, those which are selectable and those which are not selectable are displayed together. Specifically, in the left eye-use and right eye-use object image storage block, the left eye-use and right eye-use images which form the variety of objects are stored individually in the first aspect where the spaced distance is zero and the second aspect where the spaced distance has a predetermined value. Then, by the designation enable/disable determination processor, it is determined, in response to at least one of the game circumstances and the information regarding the player, whether or not each of the objects to be displayed is capable of being designated. Moreover, by the image display controller, from the left eye-use and right eye-use object image storage block, there are individually read out, in the second aspect, the left eye-use and right eye-use images of the object capable of being designated, and in the first aspect, the left eye-use and right eye-use images of the object incapable of being designated, and the left eye-use and right eye-use images thus read out are guided to one displaying storage block to be then synthesized with each other there, and thereafter, the synthesized image is read out to the display section, and is displayed on a predetermined position of the display section. In this state, by the selection processer, designation to any of the objects displayed in the second aspect on the display section is only received. Hence, the plurality of objects are displayed separately into the 2D display and the 3D stereoscopic display in response to whether or not the objects are selected, and accordingly, it becomes easy to visually recognize the state as to whether or not each of the objects is selected.

Moreover, in the video game apparatus of the present invention, the object image storage block stores the left eye-use and right eye-use images, the images forming each of the objects, while assigning the images to predetermined values on left and right transparent templates for the first and second aspects, each of the transparent template having a size of one screen, and the image display controller guides the left and right transparent templates for any one of the first and second aspects to the one displaying storage block. With such a configuration, the left and right transparent templates are read out, whereby the object to be displayed is displayed on the display screen of the display section.

In the video game apparatus of the present invention, the object image storage block assigns the left eye-use and right eye-use images, the images forming each of the objects, to any regions obtained by partitioning one screen into a plurality of regions, and stores the assigned images as left and right partial images for the first and second aspects, and the image display controller guides the left and right partial images for any one of the first and second aspects to a section of the one displaying storage block, the section being associated with the regions obtained by partitioning the one screen. With such a configuration, the left and right partial images are read out, whereby the object to be displayed is displayed on the display screen of the display section.

In the video game apparatus of the present invention, the contents associated with the objects are items for use in a game, and the selection processer associates an item of the designated object with a player. With such a configuration, when the object subjected to the 3D stereoscopic display is designated, an item associated in advance with the object, for example, an item such as a weapon for advantageously progressing the game is associated with the player. As a result, it becomes possible for the player concerned to advantageously progress the game by using the item thus associated.

In the video game apparatus of the present invention, the contents associated with the objects indicate a type of a game, and the selection processer permits execution of a game corresponding to the designated object. With such a configuration, when the object subjected to the 3D stereoscopic display is designated, a game of a type associated in advance with the object concerned is executed.

In the video game apparatus of the present invention, the at least one of game circumstances and information regarding the player is a magnitude of points acquired in a game. With such a configuration, the object subjected to the 3D stereoscopic display is not always the same, and is changed every time when the game circumstances or the information regarding the player is changed. The game circumstances also include a time-restricted game, for example, “The xx-th National Tournament Game”, in which the object is subjected to the 3D stereoscopic display during a participation period of the game, and the display of the object is changed to the 2D display after the period is ended.

### BRIEF DESCRIPTION OF THE DRAWINGS

FIG. 1 is a configuration view showing an embodiment of a game system according to the present invention;

FIG. 2 is a perspective view showing an exterior appearance of an embodiment of a game terminal;

FIG. 3 is a hardware configuration view showing the embodiment of the game terminal;

FIG. 4 is a function configuration view of a control unit of the game terminal;

FIG. 5 is a hardware configuration view showing an embodiment of a server;

FIG. 6 is a function configuration view of a control unit of the server;

FIG. 7 is a view for explaining movement of a virtual camera 60 and movement of a self-character;

FIG. 8 is a view for explaining a state where the self-character postures (gets ready for attack);

FIGS. 9A and 9B are views illustrating a principle of a 3D stereoscopic display mode of a game image: FIG. 9A is a schematic view showing a relationship between two virtual cameras and a subject; and FIG. 9B is a schematic view showing a relationship between images imaged by the two virtual cameras and a monitor image;

FIG. 10 is a configuration view for displaying the game image in the 3D stereoscopic display mode;

FIG. 11 is a view showing an example of a selection screen of a game mode;

FIG. 12 is a view showing an example of a selection screen of read information during standby for selection of players;

FIG. 13 is a view showing an example of a selection screen of an item at a predetermined point of time during a game, for example, at a time when the game is ended, and so on;

FIG. 14 is a view showing an example of a screen of a fighting game;

FIG. 15 is a flowchart illustrating a procedure of game processing executed by a game program of a CPU 161 of a game terminal 1;

FIG. 16 is a flowchart illustrating a procedure of selection processing executed by the game program of the CPU 161 of the game terminal 1;

FIG. 17 is a flowchart illustrating a procedure of selection processing executed by a game program of a CPU 361 of a server 3; and

FIG. 18 is a flowchart illustrating a procedure of game selection processing executed by the game program of the CPU 161 of the game terminal 1.

### DETAILED DESCRIPTION OF PREFERRED EMBODIMENTS

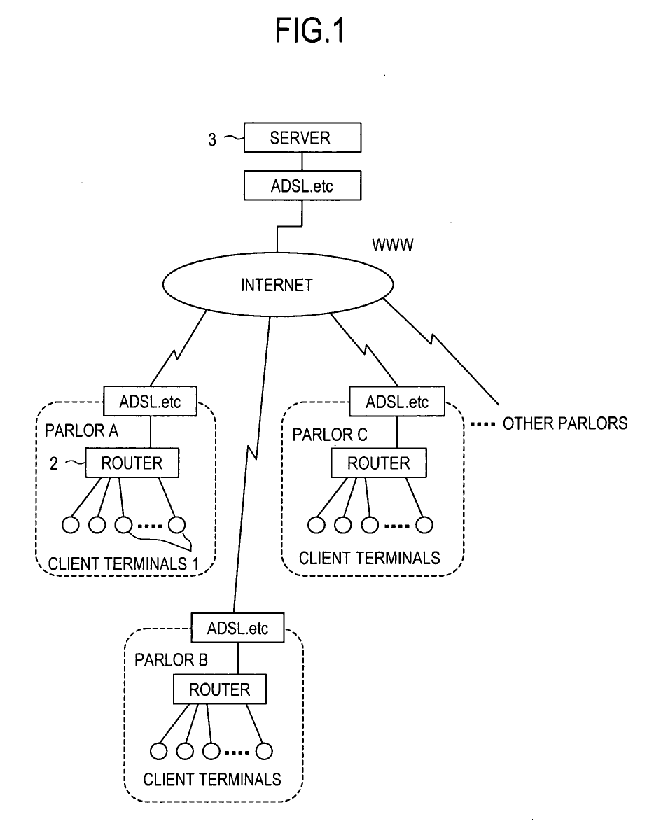

FIG. 1 is a configuration view showing an embodiment of a fighting game system to which a video game apparatus according to the present invention is applied. The fighting game system includes: client terminal devices (game terminals) 1 with which identification information is individually associated; routers 2 as communication instruments, each of which is communicably connected to a plurality (here, eight) of the game terminals 1, performs relay/connection thereamong, and performs a connection between each of the game terminals 1 and the game terminals 1 in other parlors through a network (Internet); and a server 3 that is communicably connected through the respective routers 2, and manages information regarding player authentications, player selections and game histories, which is for allowing a plurality of the players play a game by using the game terminals 1.

Each of the game terminals 1 is a terminal to progress the game in such a manner that the player performs a predetermined operation based on a game screen displayed on a monitor. Note that the identification information associated with the game terminal 1 includes: identification information for each router 2 to which the game terminal 1 is connected (or identification information of the parlor in which the game terminal 1 is arranged); and identification information for each game terminal 1 in the parlor in which the game terminal 1 is arranged (this information is referred to as a terminal number). For example, in the case where identification information of a parlor A is A, and identification information of a game terminal 1 in the parlor A is 4, then identification information of the game terminal 1 concerned is A4.

Each of the routers 2 is communicably connected to the plurality of game terminals 1 and the server 3, and performs data transmission/reception between the game terminals 1 and the server 3.

The server 3 is communicably connected to the respective routers 2, stores the player information in association with each user ID for specifying the individual player, and performs the data transmission/reception with each game terminal 1 through the router 2, thereby selects a player (referred to as an adversary) who plays the game in the same game space as that of the player concerned.

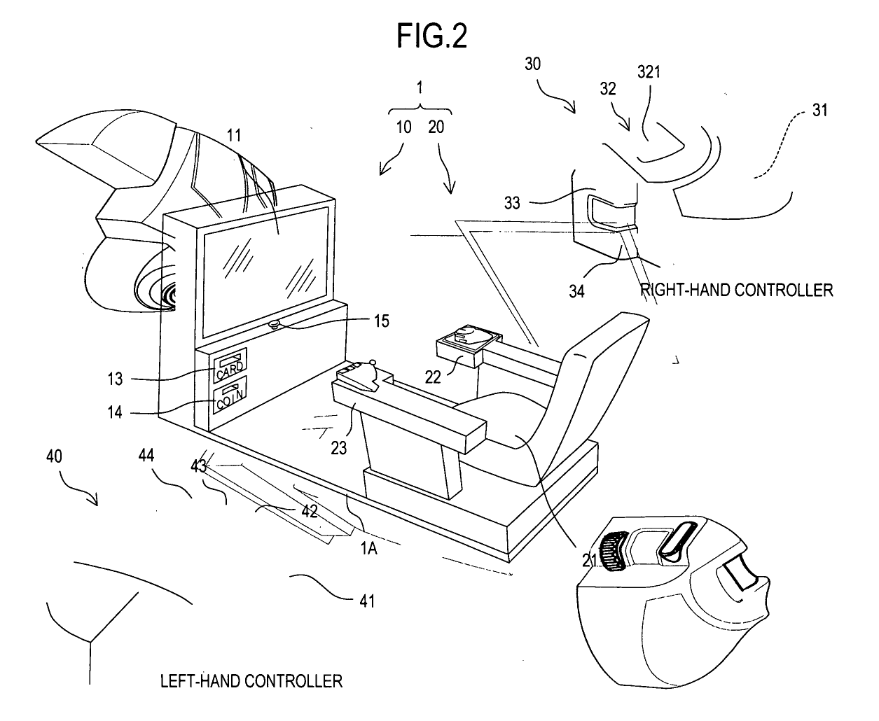

FIG. 2 is a perspective view showing an exterior appearance of an embodiment of the game terminal 1. Note that, as a fighting game played by using the game terminal 1, a shooting game is assumed among fighting games in this embodiment. In the shooting game, a one vs. one fighting mode and a group fighting mode are set. In the group fighting mode, two groups of friends and foes, each of which has a predetermined number, for example four, of players, fight against each other. The one vs. one fighting mode and the group fighting mode further include: an in-parlor fighting mode where the fighting game is played only in one parlor; and a nationwide fighting mode where the game is played among a plurality of the parlors. In the one vs. one fighting mode and the group fighting mode, operation data of both sides are transmitted and received through network communication sections 18 to be described later and the routers 2. Moreover, the nationwide fighting mode is also provided, in which the game especially takes place. In the nationwide fighting mode, the players select this mode, carry out a predetermined number of games within a predetermined period such as one week, and are thereby ranked in order of scores. Then, the ranked players are announced nationwide on monitors 11 of the game terminals, and are given gifts and the like according to needs.

The game terminal 1 includes: a monitor section 10; and a controller section 20 arranged in front of the monitor section 10, between which a mat member 1A is provided. The monitor section 10 includes: the monitor 11 formed of a liquid crystal or plasma display that displays a game image; a card reader 13 that reads contents of a personal card; a coin input section 14 through which a game fee is inserted; and an operation member for display mode designation to be described later, for example, a push-typesetter 15. The personal card is a magnetic or IC card in which the identification information of the player is stored as the user ID. Moreover, though not shown in FIG. 2, a speaker 12 that generates a sound effect at the time of attack (such as shooting), and the like is arranged.

In this embodiment, the controller section 20 includes a chair-type seating portion 21. The seating portion 21 has armrest portions 22 and 23 on left and right sides thereof. On tip ends of the right armrest portion 22 and the left armrest portion 23, a first operation member 30 and a second operation member 40, which have a size enough to be grasped by human hands, are placed. Specifically, an upper surface of the tip end of the right armrest portion 22 is formed into a flat shape, and the first operation member 30 is placed thereon. On an upper surface of the tip end of the left armrest portion 23, the second operation member 40 is placed.

The first operation member 30 includes an optical mouse 31 on a bottom surface side in an inside thereof. Moreover, on an upper surface of an outside of the first operation member 30, a trigger button 32 as a push-type switch is provided, a posture change button 33 as a push switch is provided on an upper side of a side surface thereof, and a jog dial 34 is provided on a lower side of the side surface concerned. The optical mouse 31 has a publicly known structure, and functions as a slide amount detection section. More specifically, the first operation member 30 incorporates therein: a projector that projects irradiation light irradiated onto the outside through a light transmission portion formed on a part of a bottom plate thereof; and further, an imaging element that receives and images reflected light coming from the outside. The first operation member 30 detects a change of such an external image imaged by the imaging element, thereby obtains a movement amount thereof. In order to make it possible to detect the change of the imaged image, the upper surface of the tip end of the right armrest portion 22 is formed at predetermined roughness. The first operation member 30 is operated to slide on the upper surface of the right armrest portion 22, whereby it is made possible to measure sliding amounts in the front-and-rear and right-and-left directions.

In the trigger button 32, a movable portion 321 is pushed to a main body side, whereby a movable metal slice (not shown) in an inside is brought into contact with other fixed metal slice, and so on, and an electric signal is generated. In such a way, a pushing operation is detected. The pushing operation issues an instruction to perform a shooting operation to a self-character displayed on a screen of the monitor 11.

The posture change button 33 has a structure capable of swinging on a horizontal surface, and one end side thereof is urged outward. A squatting posture is executed every time when the one end side concerned is pushed against such urging force. The jog dial 34 sets a rotation speed of a virtual camera 60, and the virtual camera rotates at a speed corresponding to a rotation amount of the dial.

The second operation member 40 includes a joystick 41 for instructing movement of the self-character, and further, on an outer front side thereof, a ready button 42, an item button 43 and an action button 44, all of which are push-type switches, are arranged. Each of the buttons 42, 43 and 44 has the same structure as that of the trigger button 32. The joystick 41 has a publicly known structure, includes an operation rod tiltable in desired directions on the horizontal surface, and outputs a signal corresponding to tilt direction and angle of the operation rod. The signal corresponding to the tilt direction and angle indicates the movement of the self-character in a virtual game screen during the game, the self-character being displayed on the screen of the monitor 11. The tilt angle indicates a movement speed, and the tilt direction indicates a movement direction. Although the movement direction may be 360 degrees, the movement direction is set at predetermined directions including the front and rear and the left and right for convenience of signal processing. For example, the movement direction is set at eight directions. Note that an aspect may be adopted, in which the moving speed is made constant regardless of the tilt angle while only switching between stop and move, or alternatively, an aspect may be adopted, in which the movement speed is set at predetermined steps, for example, two steps.

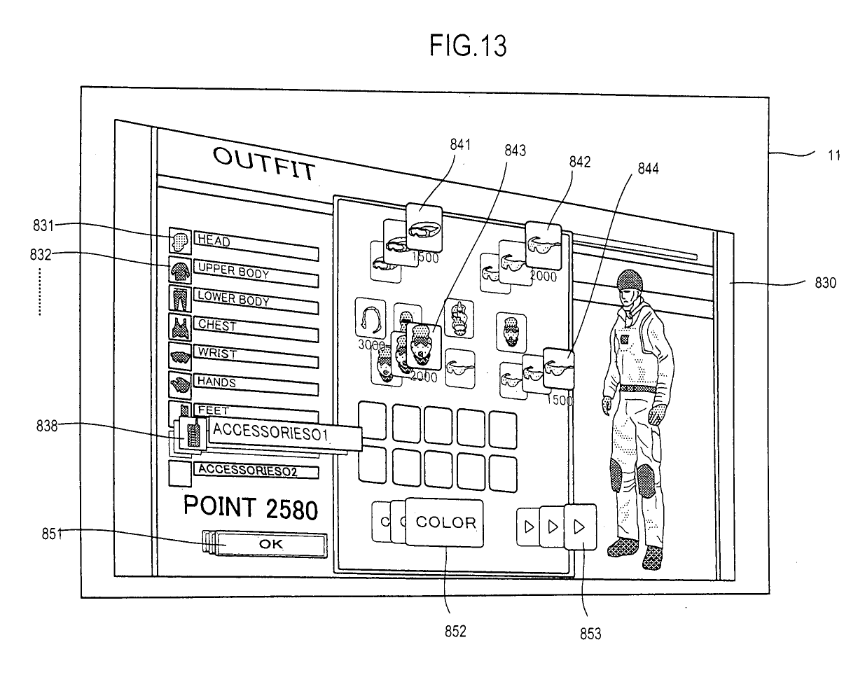

The ready button 42 functions as an attack preparation instructing member, and by a pushing operation thereto, instructs a preparation operation for allowing a weapon owned by the self-character to perform a function intrinsic to the weapon. The item button 43 is a button for changing items, and by a pushing operation thereto, designates one of plural types of the preset items (here, weapons and others (for example, OUTFIT), refer to FIG. 13). The weapons, which are suitable for the game, are prepared, and here, there are prepared a rifle and a handgun, which are virtual guns, as well as a knife, a grenade and the like. When the weapon is designated, a weapon image is virtually held by the hand of the self-character on the screen of the monitor 11. The OUTFIT will be described later with reference to FIG. 13. The action button 44 functions as a member for instructing an action, and for example, issues martial arts in close quarters.

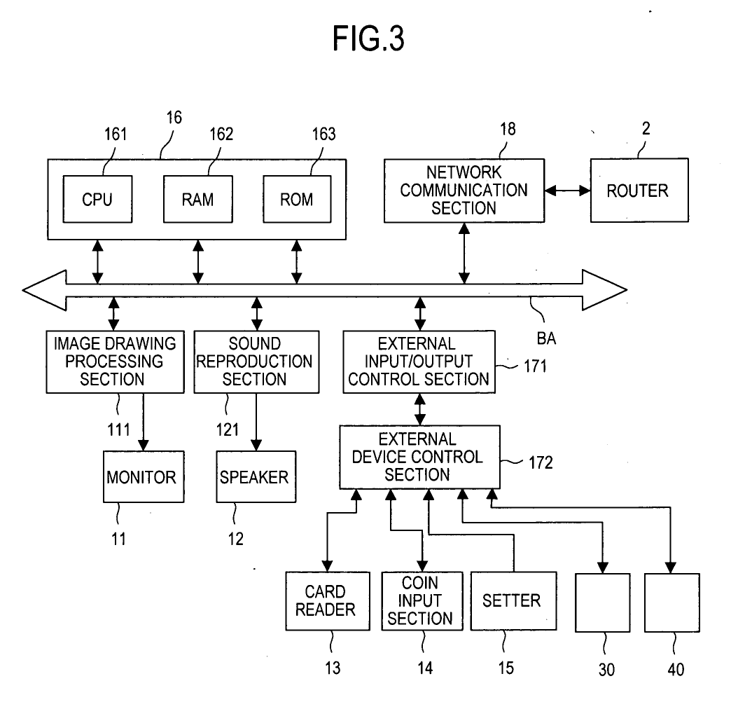

In an appropriate spot of the game terminal 1, a controller section 16 (refer to FIG. 3) composed of a microcomputer that outputs a detection signal and control signals to the respective sections, and the like is arranged.

FIG. 3 is a hardware configuration view showing an embodiment of the game terminal 1. The controller section 16 controls operations of the entire game terminal 1, and includes: a central processing unit (CPU) 161 that performs-varieties of information processing as well as processing regarding the overall progress of the game and image display processing; a RAM 162 that temporarily stores information under the processing, and the like; and a ROM 163 in which predetermined image information, game program and the like are stored in advance.

Between the controller section 16 and a detection section including the card reader 13 and the coin input section 14, an external input/output control section 171 converts detection signals into digital signals for processing, and converts instruction information into the control signals to then output the control signals to the respective instruments of the detection section. The external input/output control section 171 performs such signal processing and such input/output processing, for example, in a time division manner. Moreover, the external input/output control section 171 outputs instruction information, which corresponds to the respective operations to the button 15 and the first and second operation members 30 and 40, to the controller section 16. During the respective time division periods, an external-device control section 172 performs an output operation of the control signals to the respective instruments of the detection section, and an input operation of the detection signals from the respective instruments of the detection section.

An image drawing processing section 111 displays a required image on the monitor 11 in accordance with an image display instruction from the controller section 16, and includes a video RAM and the like. A sound reproduction section 121 outputs predetermined message, BGM and the like to the speaker 12 in accordance with an instruction from the controller section 16.

The ROM 163 stores images of the predetermined number (for example, four) of friend characters, images of the predetermined number (for example, four) of foe characters, images of the items (weapons), images of backgrounds, images of a variety of screens, and the like. Each of the images is composed of a required number of constituent polygons so as to be drawable three-dimensionally. Based on a drawing instruction from the CPU 161, the drawing processing section ill performs calculation for conversion from a world coordinate system in a three-dimensional space (virtual game space) into a local coordinate system taking the virtual camera as a reference, and further, calculation for conversion into a position on a pseudo three-dimensional space, and performs light source calculation processing, and the like. In addition, based on results of the calculations, the drawing processing section 111 performs write processing for image data to be drawn for the video RAM, for example, write (paste) processing for texture data for an area of the video RAM, which is designated by the polygons. A background is formed of a variety of objects which allow the shooting game to be directed. For example, the background is ruins of an abandoned factory, or the outdoors (urban district, inside of a forest, and the like).

Here, a description is made of a relationship between an operation of the CPU 161 and an operation of the drawing processing section 111. Based on an operating system (OS) stored in the ROM 163 that is incorporated in the game terminal 1 or attachable/detachable with an image display processer outputting the image information from the outside to the monitor 11 and displaying the image information concerned, the CPU 161 reads out, from the ROM 163, an image, an audio, control program data, and game program data that is based on a game rule. A part or all of the image, the audio and the control program data, which are read out, is held on the RAM 162. Thereafter, the CPU 161 progresses the processing based on the control program and the variety of data (image data including the polygon, texture and the like of the display object and other character images, and audio data), which are stored on the RAM 162, on the detection signal from the detection section, and on the like.

Among the variety of data stored in the ROM 163, data storable in an attachable/detachable recording medium may be made readable by drivers, for example, of a hard disk drive, an optical disk drive, a flexible disk drive, a silicon disk drive, and a cassette medium reader. In this case, the recording medium is, for example, a hard disk, an optical disk, a flexible disk, a CD, a DVD, a semiconductor memory or the like.

Through the router 2, and further, trough the network, a network communication section 18 transmits/receives operation information of the player, or the like, which is generated during the execution of the shooting game, with the game terminals 1 operated by the friend players and the foe players. Moreover, the network communication section 18 transmits/receives information at the time of entry processing for the player and game result information at the point of time when the game is ended with the server 3 through the router 2 and the like.

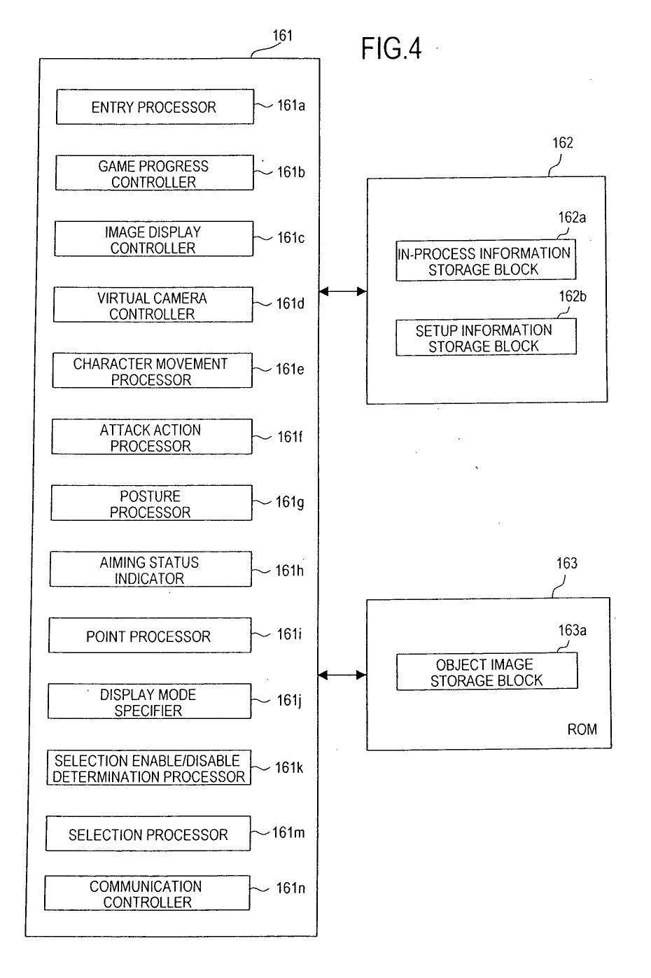

FIG. 4 is a function configuration view of the controller section 16 of the game terminal 1. The CPU 161 of the controller section 16 executes the game program and the control program, which are held on the RAM 162, and thereby functions as: an entry processer 161a that receives participation of the player in the game; a game progress controller 161b that controls a series of the progress of the game from the start to the end to progress the shooting game; and an image display controller 161c that displays, on the monitor 11, an entry image, the game image, an object image representing a button or the like to be described later, and the like. Moreover, the CPU 161 executes the game program and the control program, which are held on the RAM 162, and thereby functions as: a virtual camera controller 161d that controls a position and line of sight of the virtual camera 60 arranged in the virtual game space; a character movement processer 161e that processes a movement operation of the self-character in the virtual game space; an attack action processer 161f that processes an attack operation performed by using the weapon virtually owned by the self-character; a posture processer 161g that processes a posture operation as an attack preparation performed prior to the attack operation; an aiming status indicator 161h that displays an aim representing an attack direction, which is performed together with the execution of the posture operation; a point processer 161i that processes points concerning attacks on any foe character by the primary player's character and on the primary player's character by any foe character; a display mode specifier 161j that instructs switching between the 2D (-dimensional) display mode and the 3D (-dimensional) stereoscopic display mode as will be described later; a selection enable/disable determination processor 161k that determines whether or not the variety of objects displayed on the monitor 11 at predetermined timing (scene) are actually selectable based on game circumstances and on the information of the player; a selection processer 161m that executes processing following the entry and selection of the selection operation for the variety of objects displayed on the monitor 11; and a communication controller 161n that performs communication control for the varieties of information.

The entry processer 161a performs the entry in such a manner that the personal card is inserted into the card reader 13 of the game terminal 1, reads the user ID from the personal card, and transmits the read user ID to the server 3. In an aspect in which a plurality of the fighting modes is present, it is made possible to set the fighting mode, for example, by pushing the joystick 41 or another predetermined button or switch.

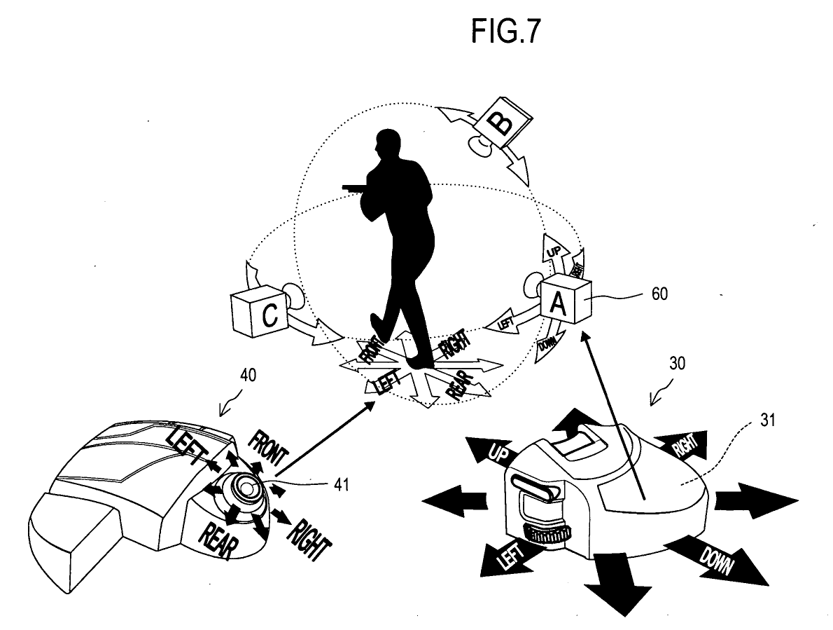

In the case where the optical mouse 31 is operated, the virtual camera controller 161d adjusts an eye point and line-of-sight direction of the virtual camera 60 in response to operation contents thereof. The virtual camera controller 161d gives the virtual camera 60 a relative positional relationship to the self-character, and sets the position of the virtual camera 60. Note that, as will be described later, in the present invention, two virtual cameras 60L and 60R are provided as the virtual camera in order to realize 3D stereoscopic display; however, details thereof will be described later. Moreover, movement of such virtual cameras 60 by the optical mouse 31 will be described with reference to FIG. 7. Furthermore, in the case where the selection processer 161m is allowed to execute the processing, as will be described later, the virtual camera controller 161d performs positional control for the virtual cameras 60L and 60R according to needs.

In the case where the joystick 41 is operated, the character movement processer 161e adjusts a movement direction and movement speed of the self-character in response to operation contents thereof. In the case where the self-character moves, the virtual camera controller 161d controls the virtual cameras 60 to make parallel movement to the movement of the self-character in order to maintain the relative positional relationship therebetween. In such a way, the game image in which the self-character is located at the center is maintained to be displayed. Such processing contents of the virtual camera controller 161d and the character movement processer 161e are reflected on the image displayed on the monitor 11 by the image display controller 161c.

FIG. 7 is a view for explaining the movement of the virtual cameras 60 and the movement of the self-character. In FIG. 7, when the optical mouse 31 is slid by a predetermined distance in the front-and-rear (up-and-down) direction, a sliding amount at this time is measured, and the virtual cameras 60 are rotated by an angle equivalent to the measured sliding amount. In the case where the optical mouse 31 is moved forward, if one of the cameras is located at a position “A” at present, then the camera rotates to a position “B” side by the angle corresponding to the sliding amount. On the contrary, in the case where the optical mouse 31 is moved rearward, the camera rotates from the position “A” to a position “C” side by the angle corresponding to the sliding amount. Moreover, in the case where the optical mouse 31 moves to left and right sides, if the camera is located at the position “A” at present, then the camera rotates in left and right directions on a horizontal surface by the angles corresponding to the sliding amounts. The virtual camera controller 161d moves the virtual camera 60 in response to the inputted sliding direction and sliding amount, and as a result, the image display controller 161c displays, on the monitor 11, an image coming out within a predetermined angle of view in the line-of-sight direction of the virtual camera 60. Hence, even if the game played in this case is a group shooting game played in the same virtual game space, the game image in which the self-character of each player is located at the center is displayed on the monitor 11 of the game terminal 1 operated by each player.

Moreover, when the operation rod of the joystick 41 is tilted by a predetermined angle in any of the front and rear and left and right directions, an electric signal corresponding to the tilt direction and angle is outputted to the character movement processer 161e. Based on the electric signal, the character movement processer 161e moves the self-character in the tilt direction at a speed corresponding to the tilt angle. With regard to the movement direction, an orientation thereof is set by taking, as a reference, a direction where the self-character is actually oriented. FIG. 7 shows a case where the self-character is moved forward. The self-character is moved in a desired direction, and thereby can approach and retreat from the foe character, whereby it becomes possible to for the self-character to progress the game advantageously. Moreover, the optical mouse 31 is operated during the movement of the self-character, whereby the self-character becomes capable of moving accurately while taking care of the periphery thereof.

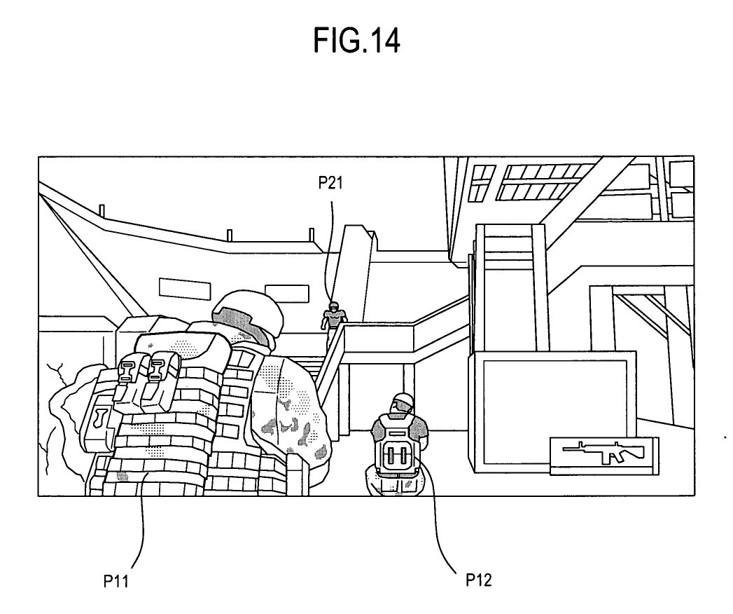

The attack action processer 161f receives an operation to the trigger button 32, and allows the self-character to attack the foe character by the weapon owned thereby. When the ready button 42 is pushed, the posture processer 161g orients the self-character in the line-of-sight direction of the virtual camera 60. Specifically, the posture processer 161g orients the weapon owned by the self-character, for example, a muzzle of the gun in agreement with or parallel to the line-of-sight direction of the virtual camera 60. Incidentally, for the eye point of the virtual camera 60, there are: a third person shooter (TPS) display mode in which the eye point is set at a position obliquely behind a part (for example, the upper-body portion) of the self-character; and a first person shooter (FPS) display mode in which the eye point is set at a face or weapon position of the self-character. When the ready button 42 is pushed, the virtual camera 60 is positionally controlled in the third person shooter display mode, and the virtual camera controller 161d allows the line-of-sight direction of the virtual camera 60 to substantially coincide with the self-character (position beyond the shoulder thereof). Hence, the center of the monitor 11 corresponds to the position beyond the shoulder of the self-character (for example, refer to FIG. 14).

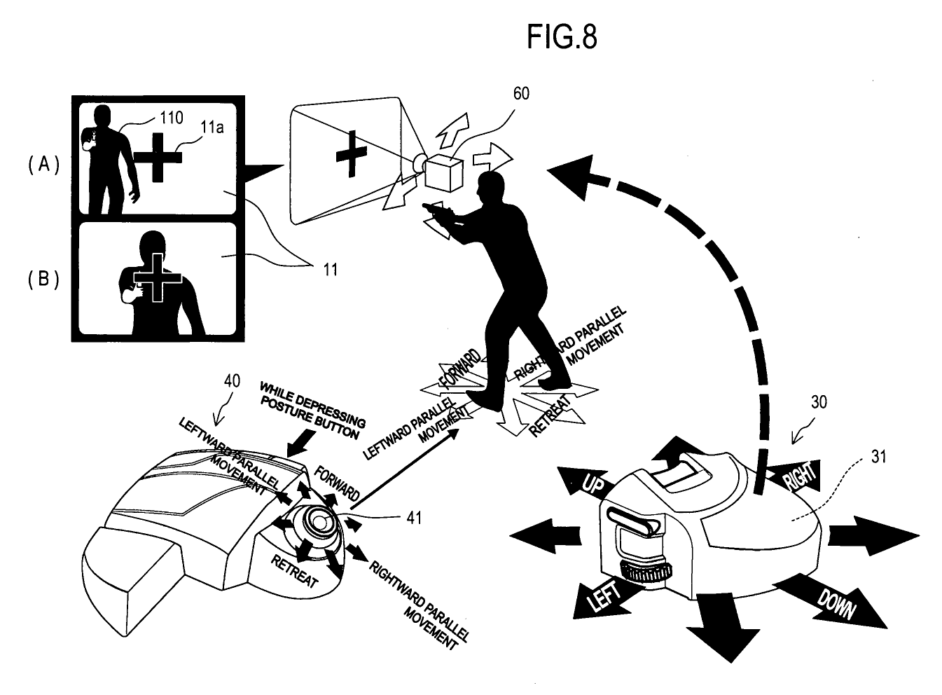

FIG. 8 is a view for explaining a state where the self-character postures (gets ready for attack). In FIG. 8, the virtual camera 60 is oriented substantially forward, and when the ready button 42 is pushed in this state, the muzzle of the virtual gun is oriented forward as the line-of-sight direction of the virtual camera 60 regardless of the orientation of the self-character. On a left side of FIG. 8, screen views A and B when such a gun object is held to be ready are illustrated. Here, the screen views A and B are displayed here in the first person shooter display mode. As in the screen view A, an aiming mark 11a representing the orientation of the muzzle is displayed on the center of the screen. The aiming status indicator 161h displays the aiming mark 11a in conduction with the operation of the posture processer 161g. In the screen view A, the aiming mark 11a and a foe character 110 do not positionally coincide with each other, and even if the trigger button 32 is pushed in this state, the foe character 110 is not hit. Accordingly, as in the screen view B, that is, the optical mouse 31 is slid by a given amount in the left direction in comparison with the screen view A, whereby the aiming mark 11a can be taken on the foe character 110. To be specific, the foe character 110 moves relatively (to the aiming mark 11a) in a manner of moving to the center of the screen of the monitor 11, whereby both thereof overlap each other. Hence, when the trigger button 32 is pushed in this state, the foe character 110 is hit.

The attack action processer 161f may calculate a ballistic trajectory of a bullet shot from the muzzle, and may display the ballistic trajectory in accordance with a calculation result. Alternatively, as in this embodiment, the attack action processer 161f may allow virtual passage of the bullet through a circle (predetermined region) having a predetermined radius from a center of the cross aiming mark 11a. In such a way, when a part of the foe character 110 is superposed on this predetermined region, the foe character 110 is hit. Note that the bullet does not always go toward the center of the cross aiming mark 11a, and for example, such processing may be performed so as to irregularly shake muzzles of a machine gun and the like, or such processing may be performed so as to shake a shooting direction during the movement of the self-character.

The point processer 161i accumulates predetermined points, for example, every time when a sniping shot is hit in the case where the attack against the foe character succeeds. At the point of time when the game is ended, the sum of the points of each of the friend side and the foe side may be obtained, and it may be thereby decided which one of both sides wins the game based on which side gains a larger number of points. Note that, in the case where the self-character is hit, the self-character may be allowed to perform, as a direction, a falling down action for a predetermined time, and for this while, may be prohibited from receiving an instruction to move or attack. Moreover, such a configuration may also be adopted, in which a predetermined life value is imparted to the player by the point processer 161i at the time when the game is started, the life value is reduced by a predetermined value every time when the player is hit, and at the point of time when the life value becomes zero, the player is prohibited from returning to the game, that is, only the player concerned is forced to end the game.

In response to the operation to the button 15 by the player, or in the case where the game progress reaches a preset predetermined situation, for example, in the case where the player postures to shoot, performs the shooting, or returns to an original state, the display mode specifier 161j determines such a situation, and automatically instructs switching of the display method between the 2D display mode and the 3D stereoscopic display mode. The 2D display mode displays a three-dimensional image without performing any processing therefor, and the 3D stereoscopic display mode imparts a three-dimensional expression to the three-dimensional image by guiding left and right images having a parallax when viewed by the left and right eyes only to the eyes individually corresponding thereto.

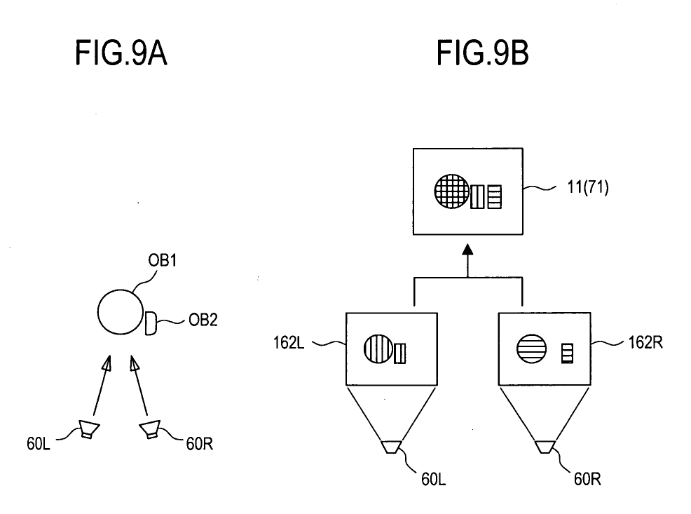

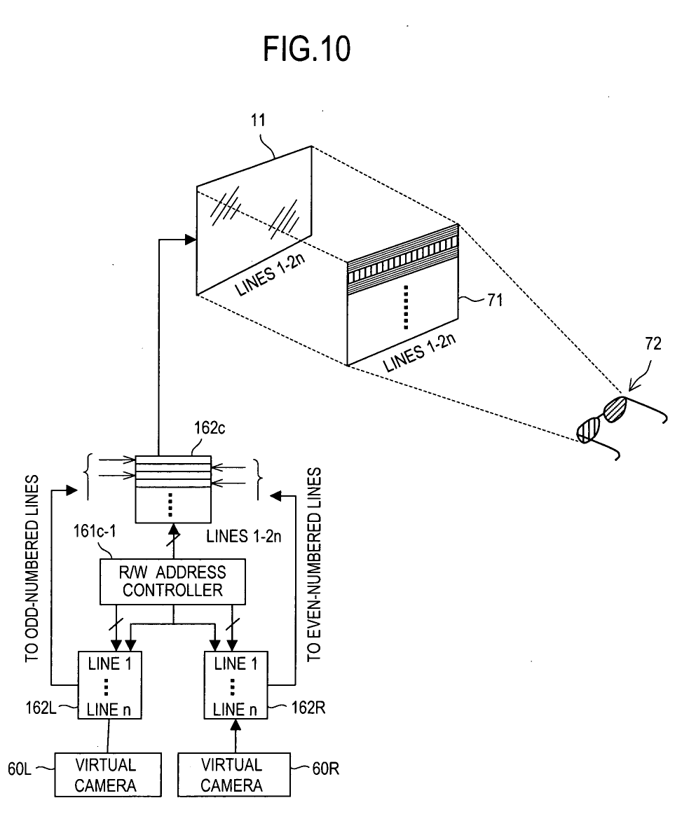

FIGS. 9A and 9B are views illustrating a principle of the 3D stereoscopic display mode of the game image: FIG. 9A is a schematic view showing a relationship between the two virtual cameras and a subject; and FIG. 9B is a schematic view showing a relationship between images imaged by the two virtual cameras and a monitor image. FIG. 10 is a configuration view for displaying the game image in the 3D stereoscopic display mode.

In the virtual game space, the two virtual cameras are prepared, which are: the virtual camera 60L for the left eye; and the virtual camera 60R for the right eye. Both of the virtual cameras 60L and 60R have a predetermined positional relationship therebetween, and the line-of-sight directions thereof intersect each other at a predetermined position in a depth direction, typically, at a position of the character or the object, which is the subject in the virtual game space. An image storage block 162L is a partial storage region in the RAM 162, and image data of one scene in the virtual game space imaged by the virtual camera 60L is written thereinto. An image storage block 162R is a partial storage region in the RAM 162, and image data of the one scene in the virtual game space imaged by the virtual camera 60R is written thereinto. Objects OB1 and OB2 shown in FIG. 9A are images of the subjects included in the scene concerned. Line of sights of the virtual cameras 60L and 60R are set toward the object OB1 here. Note that, for the sake of description convenience, the image imaged by the virtual camera 60L is expressed by vertical lines, and the image imaged by the virtual camera 60R is expressed by horizontal lines.

The respective images of the image storage blocks 162L and 162R are synthesized with each other, and are displayed on the monitor 11. As will be described later, onto the screen of the monitor 11, a sheet-like parallax barrier member 71 (for example, trade name: Xpol (registered trademark), made by Arisawa Manufacturing Co., Ltd.) is pasted. The parallax barrier member 71 is formed by regularly arraying micro-polarization elements, and includes: vertical polarization regions in which vertical slits are formed; and horizontal polarization regions in which horizontal slits are formed, alternately at a predetermined interval (equivalent to a line width of a horizontal scan line) in the vertical direction. As a result, among image light from the monitor 11, light of only vertical polarization passes through the vertical polarization regions, and light of only horizontal polarization passes through the horizontal polarization regions (refer to FIG. 9B). On glasses 72, micro-polarization elements (polarization materials) for the vertical polarization and the horizontal polarization are pasted onto left and right sides thereof, respectively. Here, the left-eye side glass allows passage of only the vertical polarization light, and the right-eye side glass allows passage of only the horizontal polarization light. Hence, the image of the polarized light from the monitor 11 is viewed while wearing (using) the glasses 72, parallax images are provided to the left and right eyes, whereby it becomes possible to view the image subjected to the 3D stereoscopic display (to obtain a three-dimensional impression).

More specifically, in FIG. 10, the virtual cameras 60L and 60R repeat imaging operations at a predetermined cycle, for example, every 1/60 (second), and images imaged at each timing are temporarily written into the image storage blocks 162L and 162R. Here, it is assumed that each of the image storage blocks 162L and 162R has a storage capacity of n lines in the vertical direction and m columns in the horizontal direction, and that a storage capacity of a video RAM 162C is 2n lines in the vertical direction and m columns in the horizontal direction.

An R/W address controller 161c-1 of the image display controller 161c sequentially reads out image data of the respective lines of the image storage block 162L, and sequentially writes the image data into odd-number lines of the video RAM 162C. Every time when such write to one line is ended, subsequently, the R/W address controller 161c-1 sequentially reads out image data of the respective lines of the image storage block 162R, and writes the image data into even-number lines of the video RAM 162C. The R/W address controller 161c-1 creates read and write addresses required for the read and write, and creates a chip select signal. By such a series of the write processing, the image data for both left and right eyes are created (synthesized) in the video RAM 162C.

The image data of the video RAM 162C is read out by the monitor 11 repeatedly at predetermined high speed. The number of pixels of the monitor 11 is 2n×m corresponding to the video RAM 162C. As shown by an image (to which vertical lines and horizontal lines are alternately imparted) in FIG. 10, in the parallax barrier member 71, the above-mentioned micro-polarization elements for the vertical polarization and the horizontal polarization are alternately arrayed for each one line of the pixels in the vertical direction.

Note that the storage capacities of the image storage blocks 162L and 162R which store the images imaged by the virtual cameras 60R and 60L may be expanded to 2n lines in the vertical direction, and may be allowed to correspond to the number of pixels of the monitor 11 in the vertical direction, whereby, in the 3D stereoscopic display, similar resolution to that in the case of the 2D display may be maintained. Moreover, the images may be directly outputted to the monitor 11 in a similar way to reading out the stored contents in the image storage blocks 162L and 162R to the video RAM 162C, that is, by making synchronization therebetween. In such a way, an aspect that does not use the video RAM 162C becomes possible.

The above description has been made of the case where the virtual cameras 60L and 60R are set at the positions different from each other and having the predetermined positional relationship. Subsequently, a description will be made of the 2D display mode.

When an instruction signal to switch from the 3D stereoscopic display mode to the 2D display mode is outputted from the display mode specifier 161j, the virtual camera controller 161d positionally controls the virtual cameras 60L and 60R so as to allow the positions and line-of-sight directions thereof to coincide with each other. As a result, the same image is imaged by the virtual cameras 60L and 60R, and the image data of the image storage blocks 162L and 162R become the same. As a result, in the video RAM 162C, the image data is filled (synthesized) in the respective lines by similar processing to that in the case of the 3D stereoscopic display. Specifically, the parallax comes not to be generated between the image for the left eye and the image for the right eye, and accordingly, the three-dimensional impression cannot be given to the player who wears the glasses 72. As a result, an ordinary display aspect is obtained, in which the three-dimensional image is displayed in the 2D display mode. Note that, in the case where an instruction signal to switch from the 2D display mode to the 3D stereoscopic display mode is outputted from the display mode specifier 161j, then on the contrary, the virtual cameras 60L and 60R are set in the predetermined positional relationship of being spaced apart from each other. As a result, the parallax is generated between both left and right eyes, and such an image capable of the stereoscopic display is obtained. In such a way, only by the processing for changing the arrangement positions of the virtual cameras 60L and 60R, it becomes possible to switch between the 2D display mode and the 3D stereoscopic display mode. A control program for such a change of the display modes is prestored in the ROM 163.

With regard to the positional relationship between the virtual cameras 60L and 60R in the 3D stereoscopic display mode, the virtual camera controller 161d sets the positions thereof in the following manner. Specifically, positional information controlled when it is assumed that the number of virtual cameras is one is taken as a reference position (center position), and the virtual cameras corresponding to the left and right sides are arranged at positions on-left and right sides from the center position, the positions being spaced apart from each other by a predetermined distance. It is natural and preferable to set a spaced distance between the virtual cameras 60L and 60R to be equivalent to a distance between both human eyes. Note that, in this case, such positional processing may be performed by taking, as the reference, the position of any one of the virtual cameras 60L and 60R.

Returning to FIG. 4, the RAM 162 of the controller section 16 includes: an in-process information storage block 162a in which game in-process information including the scores in the shooting game in the same virtual game space is sequentially stored, in an updated manner, for each player, that is, for the player him/herself and all of the friend and foe players obtained through the network communication section 18 and the communication controller 161n; and a setup information storage block 162b that stores setup information set by the varieties of switches and buttons. Every time when the game is ended and the display processing for the game result is ended, the communication controller 161n transmits the game result including the score to the server 3 together with the user ID of the player and each identification information of the game terminal 1 and the parlor.

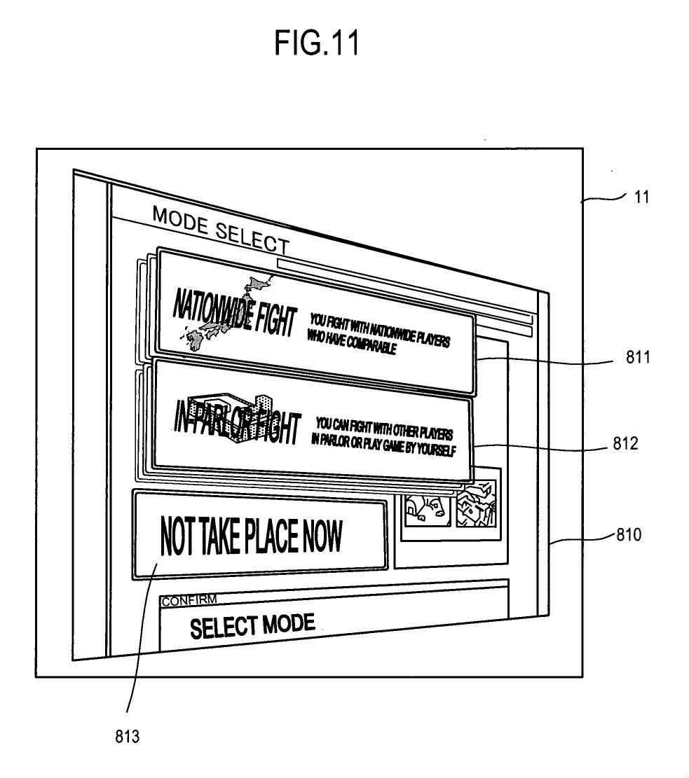

The ROM 163 includes an object image storage block 163a. The object image storage block 163a stores images of plural types of objects in categories for the 2D display (first aspect) and for the 3D stereoscopic display (second aspect). Contents (including functions) regarding the game are associated with each of the objects. For example, the functions are made recognizable by the images of the objects as well as letters written on the objects (buttons, icons). This will be specifically described by using the respective objects shown in FIG. 11 to FIG. 13.

Each object is stored in the object image storage block 163a, for example, in the following manner. First, for each object, objects categorized for the 2D display and the 3D stereoscopic display are created. For each object, the image for the left eye and the image for the right eye are prepared, and are stored in storage regions of the object image storage block 163a, which correspond thereto. The object for the 2D display is stored in the corresponding storage region at the same address (that is, at the spaced distance of zero) while setting the image for the left eye and the image for the right eye at the same one. Meanwhile, the object for the 3D stereoscopic display is stored in the corresponding storage region while setting the image for the left eye and the image for the right eye at the same one, and shifting the addresses (i.e. having the predetermined spaced distance) to left and right according to the predetermined distance (equivalent to a degree of the stereoscopic views). Note that, in the above description, the case where the object is flat is assumed, and the image for the left eye and the image for the right eye are set at the same one; however, in the case where the object is three-dimensional, the way the object looks differs between the left eye and the right eye, and both of the images are differentiated from each other.

Next, a description will be made of storage modes of each object. A first storage mode is a transparent texture equivalent to a size of one screen, in which an object image with a predetermined size is formed at a predetermined spot, that is, while being assigned to a part. Such a texture is stored as one object image in both of corresponding left and right storage regions of the object image storage block 163a. Note that a transparent portion of the texture refers to a region into which information is not written.

A second storage mode is to store the image for the left eye and the image for the right eye, which form each object, as left and right partial images for the first and second aspects in the corresponding storage regions of the object image storage block 163a while assigning these images to any regions obtained by partitioning the one screen into a plurality of regions. No matter which storage mode may be adopted, there occurs no difference on the monitor 11.

The images for the 2D display and the 3D stereoscopic display in the object image storage block 163a are read out from the corresponding regions, are written into the image storage blocks 162L and 162R, and further, are guided to the video RAM 162C to be synthesized with each other there, and subsequently, are repeatedly outputted to the monitor 11 to be then displayed as a static image.

The selection enable/disable determination processor 161k determines whether the object image to be read out by the image storage blocks 162L and 162R is the image for the 2D display or the image for the 3D stereoscopic display. The object capable of being designated (selected) by the player is subjected to the 3D stereoscopic display in order to be displayed apparently, and the object incapable of being designated by the player is subjected to the 2D display. Whether or not such designation is to be permitted is set with reference to the game circumstances (including the game progress situation), the result and others of the player. The game circumstances (including the game progress situation) refer to whether or not the current circumstances are those before the game is started, those when a stage is changed, those when the game is ended, and the like as well as the above-mentioned time-restricted event. Moreover, with regard to the result and others of the player, a difference regarding the game, an acquisition degree of information regarding the game, or the like is given between a player who gets a superior game result and a player who gets an inferior game result with reference to game histories and the like of the players. As others, it is mentioned to perform the 2D display for an object indicating the already acquired item, and so on.

At timing of object display as will be described later, as shown in FIG. 10, the image display controller 161c guides the images of the object to be displayed, which are for both of the left eye and the right eye, from the object image storage block 163a through the image storage blocks 162L and 162R to the video RAM 162C, synthesizes the images with each other there, and outputs the synthesized image to the monitor 11. Note that the images of the object to be displayed, which are for both of the left eye and the light eye, may be directly guided to the video RAM 162C to be then synthesized with each other there.

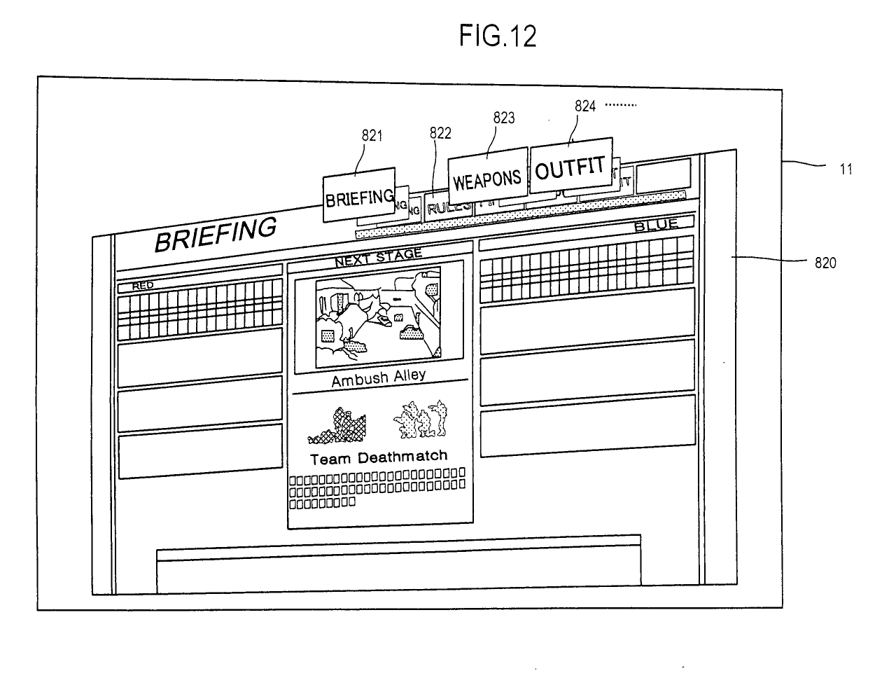

The selection processer 161m detects selection contents on selection screens displayed individually in the selection of the game mode (refer to FIG. 11), the selection of the read information during standby for the selection of players (refer to FIG. 12), and in the selection of the item at a predetermined point of time of the game, for example, at the time when the game is ended, and so on (refer to FIG. 13). Then, the selection processer 161m executes processing corresponding to the detected selection results. With regard to the display of the selection screen, the selection processer 161m forms the selection screen by using the 2D display and the 3D stereoscopic display.

FIG. 11 illustrates an example of a screen view for selecting the game mode. In FIG. 11, an erected board (panel) 810 is displayed, and on this board 810, events such as “Nationwide Fight”, “In-Parlor Fight” and “National Tournament” are displayed by objects 811, 812 and 813, which correspond thereto, respectively. Display regions of the objects 811, 812 and 813 serve as regions assigned to the respective assigned regions.

In the above description, no events take place, and on the object 813, a message saying “At present, no event takes place” is shown. Hence, the object 813 is excluded from options. Specifically, the objects 811 and 812 are displayed by the 3D stereoscopic display method in order to be shown that the objects 811 and 812 concerned are selectable, and meanwhile, the object 813 is displayed by the 2D display method in order to be shown that the object 813 concerned is not selectable. The objects 811 and 812 look like floating up from the board 810, and the object 813 looks like being written on the board 810. Note that, in FIG. 11, plural pieces of each of the objects 811 and 812 are illustrated so as to be superposed on one another; however, such an illustration simply and schematically illustrates a situation where the object concerned floats up, and is different from the actual situation. The player moves a cursor (not shown), which is displayed on the selection screen, in the screen concerned by using, for example, the joystick 41, depresses the predetermined object, for example, the item button 43 in a state where the cursor is put on a desired one of the objects 811 and 812, and is thereby made capable of selecting a desired game mode.

When the selection operation is performed for one of the objects 811 and 813, the selection processing for the game mode is executed by the selection processer 161m, and predetermined notification processing is executed in order to notify the player that the selection is received. As the predetermined notification processing, a brightness of the temporarily selected object is increased, a color thereof is differentiated from others, the 2D display and the 3D stereoscopic display are repeated predetermined times, and so on, or alternatively, an imitation sound or a sound effect, which indicates the depression of the object, is emitted.

FIG. 12 illustrates an example of a screen view for selecting the read information during the standby for the selection of the players. When the player selects a fighting game mode, selection processing for the players who play the game in the same game space in the selected fighting game mode is executed in the server 3. A time required for selecting all the players is not constant but indeterminate. Accordingly, the player in the standby state for the selection of the players is enabled to browse information regarding the game. In FIG. 12, an erected board (panel) 820 is displayed, and on this board 820, “BRIEFING”, “RULES”, “WEAPON”, “OUTFIT” . . . and the like are displayed by objects, 821, 822, 823, 824 . . . , which correspond thereto, respectively. Here, the objects 821, 823 and 824 are displayed by the 3D stereoscopic display method (look like floating up from the board 820) in order to be shown that the objects 821, 823 and 824 concerned are selectable, and meanwhile, the object 822 is displayed by the 2D display method (looks like being written on the board 820) in order to be shown that the object 822 concerned is not selectable. The player moves the cursor (not shown), which is displayed on the selection screen, in the screen concerned by using, for example, the joystick 41, depresses the predetermined object, for example, the item button 43 in a state where the cursor is put on a desired one of the objects 821, 823 and 824, and is thereby made capable of selecting to browse desired information.

When the selection operation is performed for one of the objects 821, 823 and 824, unfolding processing for such selected information on the monitor 11 is executed by the selection processer 161m, and the selected information is enabled to be browsed by the player. For example, if a reset object or the like is displayed on such a browse screen, then the player designates this object after the browse in a similar manner to the above, whereby the screen may be adapted to return to the previous screen, or may be forcibly switched to a screen ready for the start of the game on occasion that the selection processing for the players is ended.

FIG. 13 illustrates an example of a screen view for selecting the item, for example, at the time when the game is ended. At the time when the fighting game is ended and game result display processing is executed, for example, if an object that instructs a shift of the screen to an item selection screen is designated in a similar manner to the above, then the selection processer 161m switches the screen to the item selection screen. In FIG. 13, an erected board (panel) 830 is displayed, and on this board 830, items “HEAD”, “UPPER BODY” . . . “FEET”, “ACCESSORIES01” . . . are displayed by objects, 831, 832 . . . 838 . . . , which correspond thereto, respectively. Here, the object 838 is displayed by the 3D stereoscopic display method (look like floating up from the board 830) in order to be shown that the object 838 concerned is selectable, and meanwhile, other objects 831 . . . are displayed by the 2D display method (look like being written on the board 830) in order to be shown that the object 838 concerned is not selectable. The player moves the cursor (not shown), which is displayed on the selection screen, in the screen concerned by using, for example, the joystick 41, and depresses the predetermined object, for example, the item button 43 in a state where the cursor is put on the object 838, and whereby the screen concerned is switched to a purchase screen for the desired accessories 01 “ACCESSORIES 01”. FIG. 13 illustrates this scene.

In FIG. 13, on the center of the screen, those virtually purchasable (available) as the accessories 01 are displayed by the 3D stereoscopic display method, and those unavailable are displayed by the 2D display method. The available ones are “GOGGLES”, “GLASSES”, “MASK” and “GLASSES”, which are the objects 841, 842, 843 and 844. Note that numbers written under the objects shown by the 3D stereoscopic display so as to correspond thereto are virtual purchase prices. The player designates a determination object 851, which is subjected to the 3D stereoscopic display, by a similar method to the above, whereby the selection processer 161m subtracts points equivalent to the scores acquired so far by the player in the games, and allows the player to perform virtual purchase processing. Note that a value of the points owned by the player at present is read out from the server 3, and is written on the determination button 851 together therewith. The objects 841, 842, 843 and 844 are those purchasable by the current value of the points.

Moreover, a color object 852 is a designation object for so-called customization to change colors of the already acquired items. An arrow object 853 is an object for instructing to turn the screens.

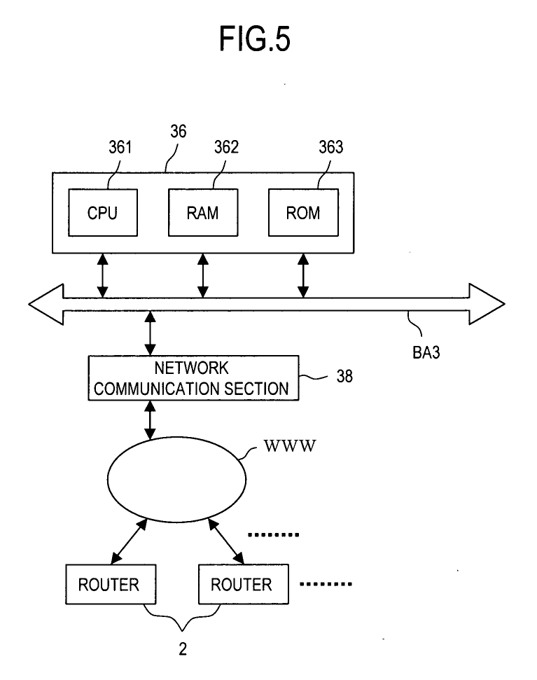

FIG. 5 is a hardware configuration view showing an embodiment of the server 3. A controller section 36 controls the entire operations of the server 3, and includes: a central processing unit (CPU) 361; a RAM 362 that temporarily stores the personal information of the players, the information regarding the games by the respective players, and the like; and a ROM 363 in which predetermined image information for management and a program for management are prestored.

Among the variety of data stored in the ROM 363, data storable in an attachable/detachable recording medium may be made readable by drives, for example, of a hard disk drive, an optical disk drive, a flexible disk drive, a silicon disk drive, and a cassette medium reader. In this case, the recording medium is, for example, a hard disk, an optical disk, a flexible disk, a CD, a DVD, a semiconductor memory or the like.

In accordance with terminal identification information, a network communication section 38 transmits/receives information with the game terminal 1, which corresponds to the terminal identification information concerned, through any one of the plurality of routers 2 via the network composed of the WWW and the like.

Note that such a management program is stored in the ROM 363, and is loaded into the RAM 362, and the game progress programs in the RAM 362 are sequentially executed by the CPU 361, whereby the respective functions thereof are realized.

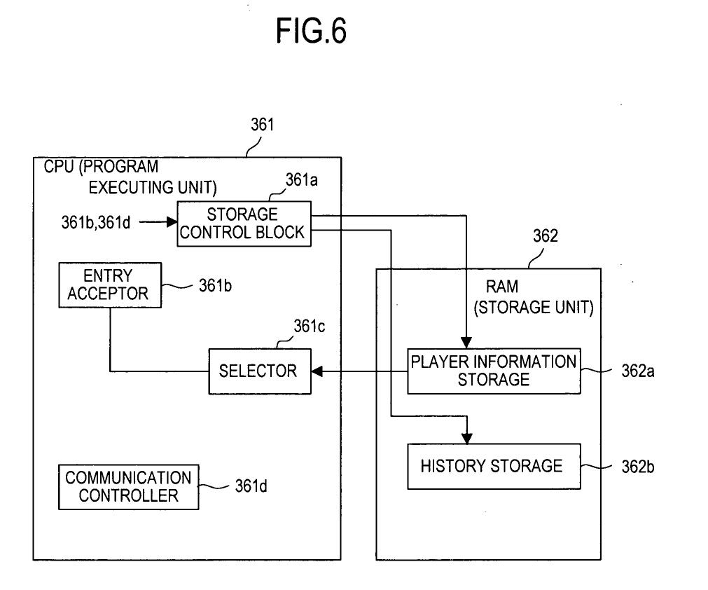

FIG. 6 is a function configuration view of the controller section 36 of the server 3. The RAM 362 includes: a player information storage block 362a that stores the personal information such as the user ID; and a history storage block 362b that stores a game history including the game results including the scores in an updated manner for each of the players.

The CPU 361 of the controller section 36 includes: a storage control block 361a that stores the respective pieces of information in the player information storage 362a and the history storage 362b; an entry acceptor 361b that executes a series of entry management processing in response to the entry of the participation of the player in the game at each of the game terminals 1; a selector 361c that selects a combination of the predetermined numbers of players (for example, four on each of the friend and foe sides), who play the game in the same virtual game space, from among the players received by the entry acceptor 361b in conformity with a rule to be described later; and a communication controller 361d that transfers the information with each of the game terminals 1.

The entry acceptor 361b receives the personal information such as the user ID of the player, which is transmitted from each of the game terminals 1, the identification information of each of the game terminals 1 and of each of the parlors, and receives the participation thereof in the game.

Moreover, in the case where the participation in the fighting game is designated from the player, the entry acceptor 361b instructs the selector 361c to perform the selection processing for the combination of the player concerned with an-opposition. In the selector 361c, a condition for positioning the players in the same game space is set, and for example, it is general that the players are positioned in order of the participation entries. In the in-parlor fighting mode, players in the same parlor are selected. Moreover, it is preferable to preferentially assign such participations, which are received from the same parlor, into the same game space. For example, such participations, which are received from the same parlor at substantially the same time, are determined to be made by players of the same group, and the players are set as the friend players. In the case where the number of friend players does not reach four as the predetermined number of members on each side (in the four vs. four game), a player who wants to participate in the game just needs to be allotted from another parlor. A foe group is decided in a similar way.

Alternatively, when participating a shooting game of a plurality of players, it may be possible to designate a friend member via operating the game terminal 1 (i.e. the master terminal of the first entry) in the same parlor by utilizing a screen of the monitor 11. Thereby, it is surely operated to define a simultaneous entry member as a friend member.

After the selector 361c connects players and the virtual game space, the communication controller 361d transmits a connection information to the game terminal 1 of the player's entry. After the connection of all the players to the virtual game space, the communication controller 361d transmits a players information (an identification information of at least each game terminal 1 operated by each player and of the parlor installed with such game terminals 1) to the game terminal 1 of each other. Thereby, it is possible to transmit/receive operational information among respective game terminals 1.

FIG. 14 is a screen view showing an example of the fighting game screen, in which a self-character P11 in a state of posturing to shoot the gun is illustrated in the TPS display mode, and a character P12 belonging to the same group is displayed, and further, a foe character P21 appears.

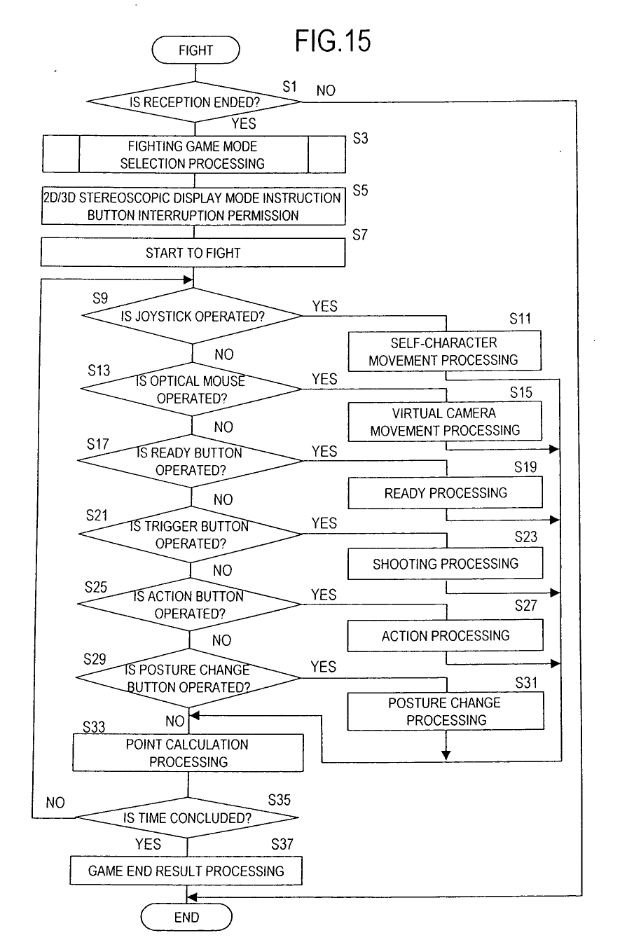

Subsequently, FIG. 15 is a flowchart illustrating a procedure of game processing executed by the game program of the CPU 161 of the game terminal 1. First, it is determined whether or not the entry is ended (Step S1). If the entry is not ended, then the game processing leaves this flow. Meanwhile, if the entry is ended, then an object for selecting the fighting game mode is displayed on the monitor 11, and so on, whereby fighting game mode selection processing is executed (Step S3).

When the selection of the fighting game mode or the like is ended, then the fight is started. Accordingly, at this point of time, interruption permission of the instruction signal for the 2D display mode and the 3D stereoscopic display mode is set (Step S5). Subsequently, the fight is started (Step S7).

In the fight, the following processing is repeated, whereby the fight progresses. Specifically, in this embodiment, it is determined whether the joystick 41 is operated (Step S9). If a result of such a determination is negative, then it is determined whether or not the optical mouse 31 is operated (Step S13). If a result of such a determination is negative, then it is determined whether or not the ready button 42 is operated (Step S17). If a result of such a determination is negative, then it is determined whether or not the trigger button 32 is operated (Step S21). If a result of such a determination is negative, then it is determined whether or not the action button 44 is operated (Step S25). If a result of such a determination is negative, then it is determined whether or not the posture change button 33 is operated (Step S29). If a result of such a determination is negative, then calculation processing for damage incurred from the foe side is executed (Step S33). In Step S33, the calculation processing is omitted in the case where the results of all the determinations are negative.

For each of the above-described determinations, in the case where the result of each of the determinations is affirmative, processing corresponding thereto is executed. Specifically, when the joystick 41 is operated, movement processing for the self-character is executed (Step S11). When the optical mouse 31 is operated, movement processing for the virtual cameras 60L and 60R is executed (Step S15). When the ready button 42 is operated, the virtual cameras 60L and 60R are set at any of the beyond-the-shoulder (third person shooter: TPS) display mode and the muzzle position (first person shooter: FPS) display mode (depending on the setting made in advance) (Step S19). Moreover, when the trigger button 32 is operated, shooting processing is executed (Step S23). When the action button 44 is operated, a fighting technique is performed in the fight (Step S27). When the posture change button 33 is operated, the posture of the self-character is changed (Step S31). Then, every time when each processing is ended, processing for an adding calculation of a damage index and a subtraction thereof according to needs is performed (Step S33). By each processing as described above, the game is progressed in response to the operations of the player, and further, in accordance with the game program.

Subsequently, by an internal timer (not shown), it is determined whether or not a predetermined game time has elapsed, that is, is concluded (Step S35). If the game time is not concluded, then the procedure returns to Step S9, and meanwhile, if the game time is concluded, then result processing at the time when the game is ended, for example, processing for the results such as the score, a rank, and an outcome (win or loose) is executed, and further, item selection processing is executed according to needs (Step S37). Then, this flow is ended. Note that details of the result processing will be described later.

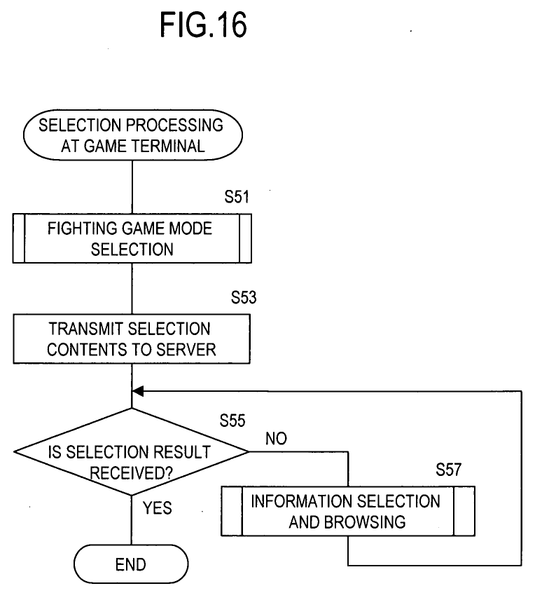

Subsequently, FIG. 16 is a flowchart illustrating a procedure of the selection processing executed by the game program of the CPU 161 of the game terminal 1. First, the selection screen shown in FIG. 11 is displayed, the fighting game mode is selected, and further, selection for a personal fight, a team fight and the like is performed according to needs (Step S51). Then, the selection contents are transmitted to the server 3 (Step S53). In the server 3, the selection processing for the player(s) is started in response to the selection contents.

Subsequently, it is determined whether or not the game terminal 1 has received the selection result of the player from the server 3 (Step S55). If the game terminal 1 has not received the selection result, then the selection screen shown in FIG. 12 is displayed on the monitor 11 of the game terminal 1, and when any of the objects is selected, the information corresponding to the selected object is unfolded on the screen (Step S57). When the game terminal 1 has received the selection result from the server 3 under this situation, this flow is ended, and the procedure proceeds to Step S5.

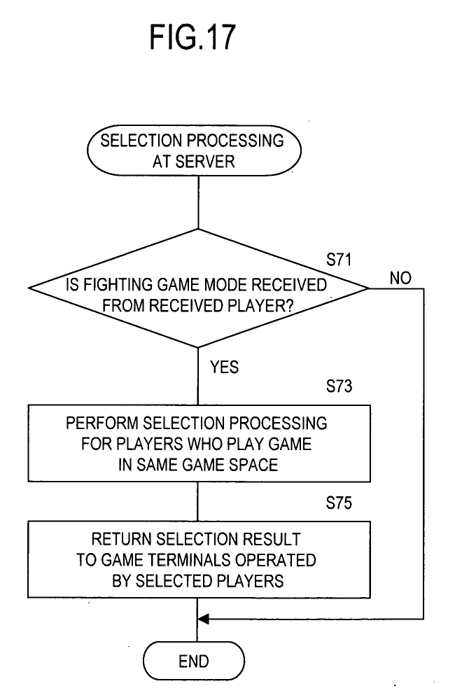

Subsequently, FIG. 17 is a flowchart illustrating a procedure of the selection processing executed by the game program of the CPU 361 of the server 3. First, it is determined whether or not the server 3 has received the information of the fighting game mode from the received player (Step S71). If the server 3 has not received the information concerned, the procedure leaves this flow. Meanwhile, if the server 3 has received the information, then the selection processing for the players who play the game in the same game space is performed (Step S73). When the selection processing is ended, the selection result is returned to the game terminals operated by the selected players (Step S75).

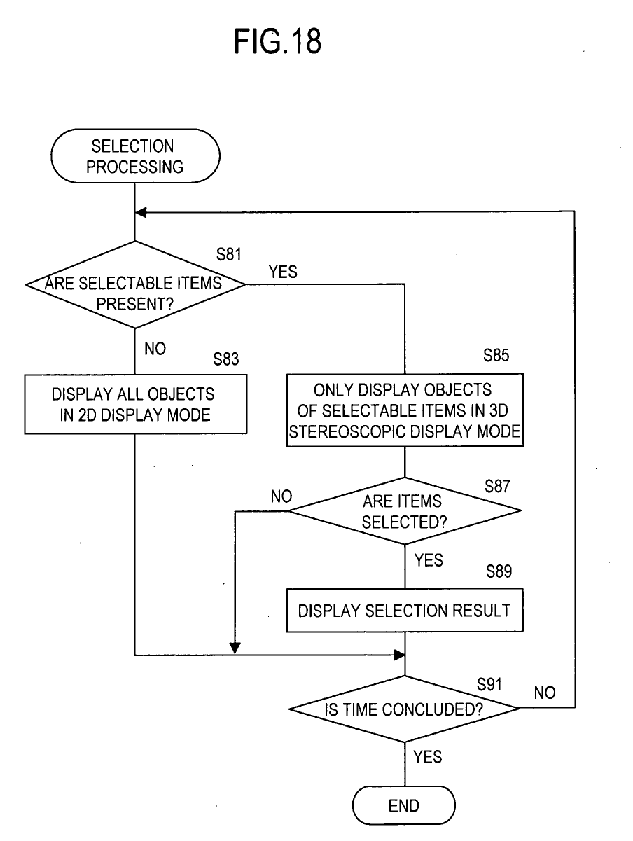

FIG. 18 is a flowchart illustrating a procedure of the selection processing executed by the game program of the CPU 161 of the game terminal 1. First, it is determined whether or not the selectable items are present (Step S81). If the selectable items are not present, all the objects are displayed in the 2D display mode (Step S83). Meanwhile, if the selectable items are present, only the objects corresponding thereto are displayed in the 3D stereoscopic mode (Step S85). Then, it is determined whether or not the items are selected (Step S87). If the items are selected, then selection result display for issuing a notice that the items to be adopted according to needs are selected is executed (Step S89), and the procedure proceeds to Step S91. Meanwhile, if the items are not selected, the processing skips Step S89 and proceeds to Step S91. In Step S91, it is determined whether or not a predetermined time has elapsed, that is, is concluded since the screen is switched to the selection screen. If the time is not concluded, then the procedure returns to Step S81, and if the time is concluded, then this flow is ended.

Note that the present invention is capable of adopting the following aspects.

(1) In this embodiment, the description has been made of the case where the game is the fighting game that employs the first and second operation members 30 and 40. However, the present invention is applicable to a variety of games, and the first and second operation members 30 and 40 are merely examples. Any game may be executed as long as the game is executed in the virtual game space, and the virtual cameras are movable in response to the game progress and the like in the virtual game space, and in response to the operations by the player. Moreover, with regard to the types of the game, the present invention is also applicable to a grapple game, fighting games simulating baseball and soccer, a competition game such as a time trial, a mahjong game, a growing game of growing a character, and the like.

(2) Moreover, in this embodiment, the glasses are treated as an essential element; however, in the case of adopting the following aspect, the glasses do not have to be employed. Specifically, the parallax panoramagram method and the lenticular method may be adopted as examples of a non-glass method.

(3) In this embodiment, in the drawing of the 2D display mode, the image storage blocks 162L and 162R are operated by the same method as in the case of the 3D stereoscopic display mode. However, in place of this, in the 2D display mode, an aspect may also be adopted, in which one of the image storage blocks 162L and 162R is used, the image of each line is read out twice, and is written into continuous two lines of the video RAM 162C. With such an aspect, the 2D display can be obtained only one of the image storage blocks. Moreover, without employing the image storage blocks 162L and 162R, the respective game images imaged by the two virtual cameras 60L and 60R may be directly written into the video RAM 162C alternately for each of the lines.

(4) In this embodiment, a relationship of each of the storage capacities of the image storage blocks 162L and 162R to the storage capacity of the video RAM 162C and the number of pixels of the monitor 11 is set at a ratio of 1 to 2; however, the relationship is not limited to this. Specifically, each of the storage capacities of the image storage blocks 162L and 162R may be equalized to that of the video RAM 162C. In this case, in the 3D stereoscopic display mode, the image data of the odd-number lines of the image storage block 162L and of the even-number lines of the image storage blocks 162R just need to be written into the addresses of the video RAM 162C, which correspond thereto. Meanwhile, in the 2D display mode, an aspect just needs to be adopted, in which the image data of one of the image storage blocks 162L and 162R is read out, and is directly written into the video RAM 162C. In this case, it becomes possible to draw the image in the 2D display mode by using the data from one of the image storage blocks. In addition, each of the storage blocks is set to have the equal storage capacity to that of the video RAM 162C, and accordingly, a game image with high resolution can be presented.

As described above, it is preferable that the video game apparatus according to the present invention be a video game apparatus that selectably presents, to a player, a variety of objects with which contents regarding a game are associated, the video game apparatus including: a display section in which a parallax barrier member enabling 3D stereoscopic display is arranged on a display screen; a left eye-use and right eye-use object image storage block that stores left eye-use and right eye-use images forming each of the objects individually in a first aspect where a spaced distance is zero and a second aspect where the spaced distance has a predetermined value; a designation enable/disable determination processor that determines, in response to at least one of game circumstances and information regarding the player, whether or not each of the objects to be displayed is capable of being designated; an image display controller that individually reads out, in the second aspect, the left eye-use and right eye-use images of the object capable of being designated, and in the first aspect, the left eye-use and right eye-use images of the object incapable of being designated, from the left eye-use and right eye-use object image storage block, then guides the read out left eye-use and right eye-use images to one displaying storage block to then synthesize the left eye-use and right eye-use images with each other there, and thereafter, reads out the synthesized image to the display section, and displays the synthesized image on a predetermined position of the display section; and a selection processer that receives designation to any of the objects displayed in the second aspect on the display section.

In accordance with such an invention, it becomes possible for the player to view the game image in the 3D stereoscopic display mode through the display section. On the display section, the variety of objects with which the contents regarding the game are associated are displayed, and with regard to the objects, those which are selectable and those which are not selectable are displayed together. Specifically, in the left eye-use and right eye-use object image storage block, the left eye-use and right eye-use images which form the variety of objects are stored individually in the first aspect where the spaced distance is zero and the second aspect where the spaced distance has a predetermined value. Then, by the designation enable/disable determination processor, it is determined, in response to at least one of the game circumstances and the information regarding the player, whether or not each of the objects to be displayed is capable of being designated. Moreover, by the image display controller, from the left eye-use and right eye-use object image storage block, there are individually read out, in the second aspect, the left eye-use and right eye-use images of the object capable of being designated, and in the first aspect, the left eye-use and right eye-use images of the object incapable of being designated, and the left eye-use and right eye-use images thus read out are guided to one displaying storage block to be then synthesized with each other there, and thereafter, the synthesized image is read out to the display section, and is displayed on a predetermined position of the display section. In this state, by the selection processer, designation to any of the objects displayed in the second aspect on the display section is only received. Hence, the plurality of objects are displayed separately into the 2D display and the 3D stereoscopic display in response to whether or not the objects are selected, and accordingly, it becomes easy to visually recognize the state as to whether or not each of the objects is selected.

Moreover, in the video game apparatus of the present invention, preferably, the object image storage block stores the left eye-use and right eye-use images, the images forming each of the objects, while assigning the images to predetermined values on left and right transparent templates for the first and second aspects, each of the transparent template having a-size of one screen, and the image display controller guides the left and right transparent templates for any one of the first and second aspects to the one displaying storage block. With such a configuration, the left and right transparent templates are read out, whereby the object to be displayed is displayed on the display screen of the display section.

In the video game apparatus of the present invention, preferably, the object image storage block assigns the left eye-use and right eye-use images, the images forming each of the objects, to any regions obtained by partitioning one screen into a plurality of regions, and stores the assigned images as left and right partial images for the first and second aspects, and the image display controller guides the left and right partial images for any one of the first and second aspects to a section of the one displaying storage block, the section being associated with the regions obtained by partitioning the one screen. With such a configuration, the left and right partial images are read out, whereby the object to be displayed is displayed on the display screen of the display section.

In the video game apparatus of the present invention, preferably, the contents associated with the objects are items for use in a game, and the selection processer associates an item of the designated object with a player. With such a configuration, when the object subjected to the 3D stereoscopic display is designated, an item associated in advance with the object, for example, an item such as a weapon for advantageously progressing the game is associated with the player. As a result, it becomes possible for the player concerned to advantageously progress the game by using the item thus associated.

In the video game apparatus of the present invention, preferably, the contents associated with the objects indicate a type of a game, and the selection processer permits execution of a game corresponding to the designated object. With such a configuration, when the object subjected to the 3D stereoscopic display is designated, a game of a type associated in advance with the object concerned is executed.

In the video game apparatus of the present invention, preferably, the at least one of game circumstances and information regarding the player is a magnitude of points acquired in a game. With such a configuration, the object subjected to the 3D stereoscopic display is not always the same, and is changed every time when the game circumstances or the information regarding the game is changed. The game circumstances also include a time-restricted game, for example, “The xx-th National Tournament Game”, in which the object is subjected to the 3D stereoscopic display during a participation period of the game, and the display of the object is changed to the 2D display after the period is ended.

What is claimed is:

1. A video game apparatus that selectably presents, to a player, a variety of objects with which contents regarding a game are associated, the video game apparatus comprising:
a display section in which a parallax barrier member enabling 3D stereoscopic display is arranged on a display screen;
a left eye-use and right eye-use object image storage block that stores left eye-use and right eye-use images forming each of the objects individually in a first aspect where a spaced distance is zero and a second aspect where the spaced distance has a predetermined value;
a designation enable/disable determination processor that determines, in response to at least one of game circumstances and information regarding the player, whether or not each of the objects to be displayed is capable of being designated;
an image display controller that individually reads out, in the second aspect, the left eye-use and right eye-use images of the object capable of being designated, and in the first aspect, the left eye-use and right eye-use images of the object incapable of being designated, from the left eye-use and right eye-use object image storage block, then guides the read out left eye-use and right eye-use images to one displaying storage block to then synthesize the left eye-use and right eye-use images with each other there, and thereafter, reads out the synthesized image to the display section, and displays the synthesized image on a predetermined position of the display section; and
a selection processer that receives designation to any of the objects displayed in the second aspect on the display section.

2. The video game apparatus according to claim 1, wherein the object image storage block stores the left eye-use and right eye-use images, the images forming each of the objects, while assigning the images to predetermined values on left and right transparent templates for the first and second aspects, each of the transparent template having a size of one screen, and the image display controller guides the left and right transparent templates for any one of the first and second aspects to the one displaying storage block.

3. The video game apparatus according to claim 1, wherein the object image storage block assigns the left eye-use and right eye-use images, the images forming each of the objects, to any regions obtained by partitioning one screen into a plurality of regions, and stores the assigned images as left and right partial images for the first and second aspects, and the image display controller guides the left and right partial images for any one of the first and second aspects to a section of the one displaying storage block, the section being associated with the regions obtained by partitioning the one screen.

4. The video game apparatus according to claim 1, wherein the contents associated with the objects are items for use in a game, and the selection processer associates an item of the designated object with a player.

5. The video game apparatus according to claim 4, wherein the at least one of game circumstances and information regarding the player is a magnitude of points acquired in a game.

6. The video game apparatus according to claim 1, wherein the contents associated with the objects indicate a type of a game, and the selection processer permits execution of a game corresponding to the designated object.

7. The video game apparatus according to claim 6, wherein the at least one of game circumstances and information regarding the player is a magnitude of points acquired in a game.

8. A game information display control method of a video game apparatus that includes a display section in which a parallax barrier member enabling 3D stereoscopic display is arranged on a display screen, and selectably displays, on the display section, a variety of objects with which contents regarding a game are associated, the game information display control method comprising:
allowing a left eye-use and right eye-use object image storage block to store left eye-use and right eye-use images forming each of the objects individually in a first aspect where a spaced distance is zero and a second aspect where the spaced distance has a predetermined value;
allowing a designation enable/disable determination processor to determine, in response to at least one of game circumstances and information regarding a player, whether or not each of the objects to be displayed is capable of being designated;
allowing an image display controller to individually read out, in the second aspect, the left eye-use and right eye-use images of the object capable of being designated, and in the first aspect, the left eye-use and right eye-use images of the object incapable of being designated, from the left eye-use and right eye-use object image storage block, then to guide the read out left eye-use and right eye-use images to one displaying storage block and then synthesize the left eye-use and right eye-use images with each other there, and thereafter, to read out the synthesized image to the display section, and to display the synthesized image on a predetermined position of the display section; and
allowing a selection processer to receive designation to any of the objects displayed in the second aspect on the display section.

9. A game information display control program of a video game apparatus that includes a display section in which a parallax barrier member enabling 3D stereoscopic display is arranged on a display screen, and selectably displays, on the display section, a variety of objects with which contents regarding a game are associated, the game information display control program allowing the video game apparatus to function as:
a left eye-use and right eye-use object image storage block that stores left eye-use and right eye-use images forming each of the objects individually in a first aspect where a spaced distance is zero and a second aspect where the spaced distance has a predetermined value;
a designation enable/disable determination processor that determines, in response to at least one of game circumstances and information regarding a player, whether or not each of the objects to be displayed is capable of being designated;
an image display controller that individually reads out, in the second aspect, the left eye-use and right eye-use images of the object capable of being designated, and in the first aspect, the left eye-use and right eye-use images of the object incapable of being designated, from the left eye-use and right eye-use object image storage block, then guides the read out left eye-use and right eye-use images to one displaying storage block to then synthesize the left eye-use and right eye-use images with each other there, and thereafter, reads out the synthesized image to the display section, and displays the synthesized image on a predetermined position of the display section; and
a selection processer that receives designation to any of the objects displayed in the second aspect on the display section.
